(19) United States
(12) Patent Application Publication
(10) Pub. No.: US 2023/0072129 A1
(43) Pub. Date: Mar. 9, 2023

(54) COMPUTER-IMPLEMENTED METHODS, SYSTEMS COMPRISING COMPUTER-READABLE MEDIA, AND ELECTRONIC DEVICES FOR DETECTING PROCEDURE AND DIAGNOSIS CODE ANOMALIES THROUGH MATRIX-TO-GRAPHICAL CLUSTER TRANSFORMATION OF PROVIDER SERVICE DATA

(71) Applicant: Mastercard International Incorporated, Purchase, NY (US)

(72) Inventors: Nitish Kumar, Jamshedpur (IN); Alok Singh, Gurgaon (IN); Deepak Chaurasiya, New Delhi (IN); Kushagra Agarwal, Gurgaon (IN)

(73) Assignee: Mastercard International Incorporated, Purchase, NY (US)

(21) Appl. No.: 17/901,262

(22) Filed: Sep. 1, 2022

Related U.S. Application Data
(60) Provisional application No. 63/240,580, filed on Sep. 3, 2021.

(51) Int. Cl. G06Q 40/08

(52) U.S. Cl. CPC G06Q 40/08

(57) ABSTRACT

Computer implemented method for detecting procedure and diagnosis code anomalies in provider service data. The method includes generating a co-occurrence adjacency matrix from service provider data of a plurality of providers. The adjacency matrix includes counts of the number of co-occurrences of a plurality of diagnoses and a plurality of procedures in the service provider data. A plurality of graph node embeddings is created based on the adjacency matrix. Each of the plurality of graph node embeddings is assigned to one of a plurality of clusters. A health insurance claim is evaluated for excessive billing based on how many of the plurality of clusters is represented in the claim.

### RELATED APPLICATIONS

The present application is a non-provisional application which claims priority benefit with regard to all common subject matter to identically-titled U.S. Provisional Application Ser. No. 63/240,580, filed Sep. 3, 2021, which is hereby incorporated by reference in its entirety into the present application as if fully set forth herein.

### FIELD OF THE INVENTION

The present disclosure generally relates to computer-implemented methods, systems comprising computer-readable media, and electronic devices for detecting procedure and diagnosis code anomalies in provider service data. More particularly, the present disclosure generally relates to detecting procedure and diagnosis code anomalies through transformation of the service data to graphical clusters via co-occurrence adjacency matrices, node embedding and graph clustering techniques.

### BACKGROUND

Existing methods for detecting procedure and diagnosis code anomalies or fraud in provider service data (e.g., healthcare service provider) focus, for example, on detecting internal inconsistencies with respect to a given entity (i.e., a given provider or patient) using internal entity profiles and data tables. There is a need for improved computer-implemented methods, systems comprising computer-readable media, and electronic devices for detecting procedure and diagnosis code anomalies with adjusted focus and varied data transformation measures.

This background discussion is intended to provide information related to the present invention which is not necessarily prior art.

### BRIEF SUMMARY

Embodiments of the present technology relate to computer-implemented methods, systems comprising computer-readable media, and electronic devices for detecting procedure and diagnosis code anomalies in provider service data. The embodiments may include converting matrix data to graphical clusters to reveal previously undetectable correlations and/or anomalies in the data to, for example, support identification of instances of medical billing for excessive and/or unnecessary service(s).

More particularly, in a first aspect, a computer-implemented method for detecting procedure and diagnosis code anomalies in provider service data may be provided. The method includes generating a co-occurrence adjacency matrix from service provider data of a plurality of providers. The adjacency matrix includes counts of the number of co-occurrences of a plurality of diagnoses and a plurality of procedures in the service provider data. A plurality of graph node embeddings is created based on the adjacency matrix. Each of the plurality of graph node embeddings is assigned to one of a plurality of clusters. A health insurance claim is evaluated for excessive billing based on how many of the plurality of clusters are represented in the claim. The method may include additional, less, or alternate actions, including those discussed elsewhere herein.

In another aspect, a system for detecting procedure and diagnosis code anomalies in provider service data may be provided. The system may include one or more processors individually or collectively programmed to perform the following steps: generate a co-occurrence adjacency matrix from service provider data of a plurality of providers, the adjacency matrix including counts of the number of co-occurrences of a plurality of diagnoses and a plurality of procedures in the service provider data; create a plurality of graph node embeddings based on the adjacency matrix; assign each of the plurality of graph node embeddings to one of a plurality of clusters; and evaluate a health insurance claim for excessive billing based on how many of the plurality of clusters are represented in the claim. The system may include additional, less, or alternate functionality, including that discussed elsewhere herein.

In still another aspect, a system comprising computer-readable media having computer-executable instructions stored thereon for detecting procedure and diagnosis code anomalies in provider service data may be provided. The computer-readable instructions may instruct at least one processor to perform the following steps: generate a co-occurrence adjacency matrix from service provider data of a plurality of providers, the adjacency matrix including counts of the number of co-occurrences of a plurality of diagnoses and a plurality of procedures in the service provider data; create a plurality of graph node embeddings based on the adjacency matrix; assign each of the plurality of graph node embeddings to one of a plurality of clusters; and evaluate a health insurance claim for excessive billing based on how many of the plurality of clusters are represented in the claim. The computer-readable instructions may instruct the processor(s) to perform additional, fewer, or alternative actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various components, in block schematic form, of an exemplary system for detecting procedure and diagnosis code anomalies in provider service data in accordance with embodiments of the present invention;

FIGS. 2 and 3 respectively illustrate various components of an exemplary computing device and server shown in block schematic form that may be used with the system of FIG. 1;

FIG. 4 illustrates an exemplary set of provider claims and corresponding diagnosis and procedure codes that may be used to create an adjacency matrix for use with the system of FIG. 1;

FIG. 5 illustrates an exemplary adjacency matrix generated from the table of provider data shown in FIG. 4;

FIG. 6 illustrates exemplary graph node embeddings partitioned into a plurality of clusters that may be used with the system of FIG. 1; and

FIG. 7 is a flowchart illustrating at least a portion of the steps for detecting procedure and diagnosis code anomalies in provider service data in accordance with embodiments of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Existing methods for detecting procedure and diagnosis code anomalies or fraud in provider service data (e.g., healthcare service provider) focus, for example, on detecting internal inconsistencies with respect to a given entity (i.e., a given provider or patient) using internal entity profiles and data tables. However, existing methods are myopic with respect to data sets examined and relationships revealed in lower-dimensional embedded spaces.

According to embodiments of the present invention, detecting anomalous procedure codes is achieved through a specific, concrete set of steps for data transformation to a lower-dimensional embedded space that allows revelation of previously undetectable relationships and correlations.

### Exemplary System

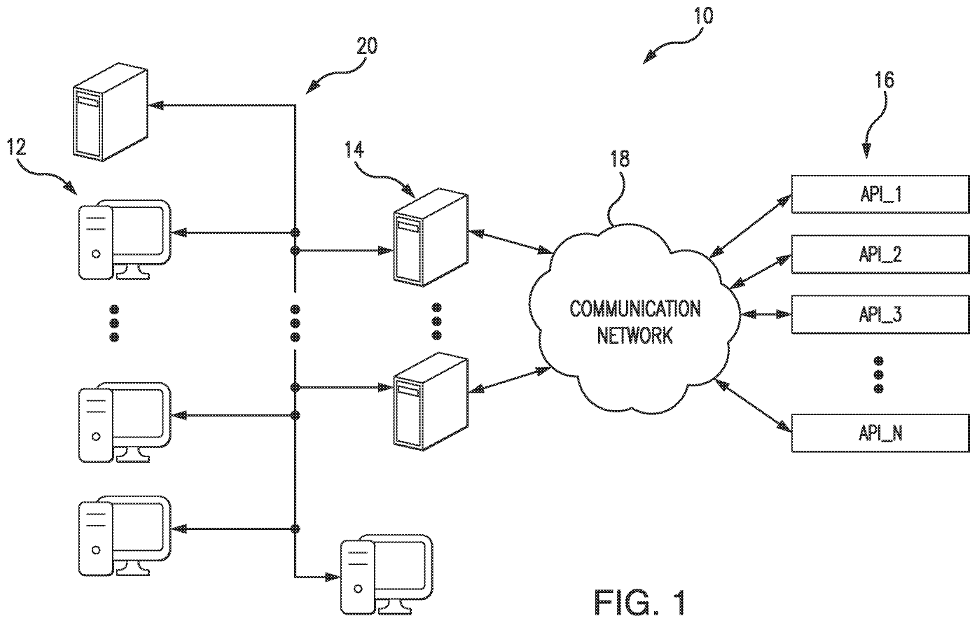

FIG. 1 depicts an exemplary environment 10 for detecting procedure and diagnosis code anomalies or fraud in provider service data according to embodiments of the present invention. The environment 10 may include a plurality of computers 12, a plurality of servers 14, a plurality of application programming interfaces (APIs) 16, and a communication network 18. The computers 12 and the servers 14 may be located within network boundaries of a large organization, such as a corporation, a government office, or the like. The communication network 18 and the APIs 16 may be external to the organization, for example where the APIs 16 are offered by healthcare providers and/or insurance providers or related third parties making healthcare insurance claims data available for analysis.

More particularly, the computers 12 and servers 14 may be connected to an internal network 20 of the organization, which may comprise a trusted internal network or the like. Alternatively or in addition, the computers 12 and servers 14 may manage access to the APIs 16 under a common authentication management framework. Each user of a device 12 may be required to complete an authentication process to access data obtained from the APIs 16 via the servers 14. In one or more embodiments, one or more computers 12 may not be internal to the organization, but may be permitted access to perform the queries via the common authentication management framework. For instance, the common authentication management framework may comprise one or more servers made available under WebSEAL® (a registered trademark of International Business Machines Corporation) as of the date of initial filing of the present disclosure. Moreover, all or some of the APIs 16 may be maintained and/or owned by the organization and/or may be maintained on the internal network 20 within the scope of the present invention. One of ordinary skill will appreciate that the servers 14 may be free of, and/or subject to different protocol(s) of, the common authentication management framework within the scope of the present invention.

Data made available via the APIs 16 may include provider data comprising medical or healthcare insurance claims data. Further, the servers 14 may be maintained by a payment network organization or government organization, and an authenticated employee of the foregoing may access an exemplary system implemented on the servers 14 to query the APIs 16 and/or use the obtained information to perform fraud or excessive billing analyses. An employee of the payment network organization or government organization may also access such an exemplary system from a computer 12 to query the APIs 16 and/or use the obtained information to perform fraud or excessive billing analyses. One of ordinary skill will appreciate that embodiments may serve a wide variety of organizations and/or rely on a wide variety of datasources within the scope of the present invention. For example, one or more datasources accessed by a system according to embodiments of the present invention may be available to the public. Moreover, one of ordinary skill will appreciate that different combinations of one or more computing devices—including a single computing device or server—may implement embodiments without departing from the spirit of the present invention.

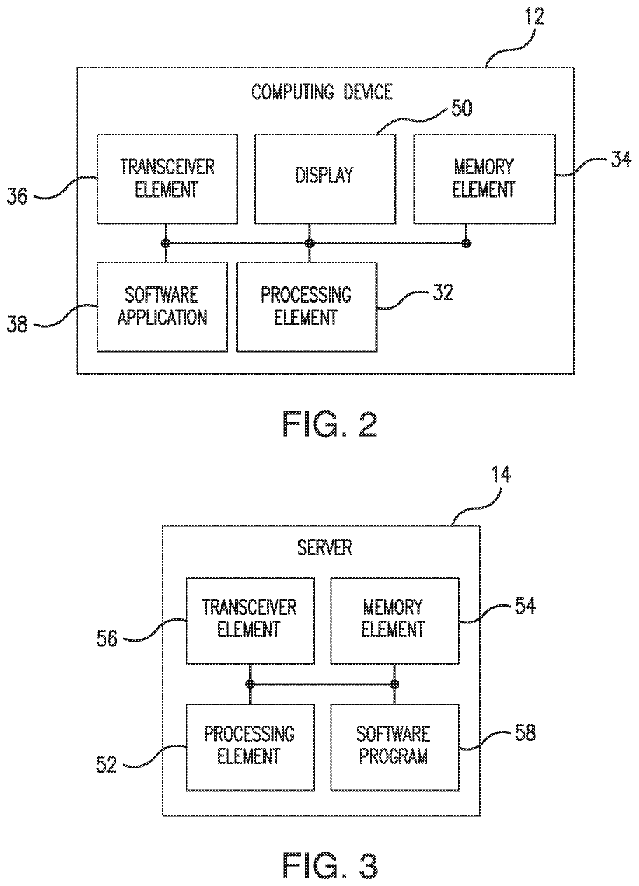

The computers 12 may be workstations. Turning to FIG. 2, generally the computers 12 may include tablet computers, laptop computers, desktop computers, workstation computers, smart phones, smart watches, and the like. In addition, the computers 12 may include copiers, printers, routers and any other device that can connect to the internal network 20 and/or the communication network 18. Each computer 12 may include a processing element 32 and a memory element 34. Each computer 12 may also include circuitry capable of wired and/or wireless communication with the internal network 20 and/or the communication network 18, including, for example, transceiver elements 36. Further, the computers 12 may respectively include a software application 38 configured with instructions for performing and/or enabling performance of at least some of the steps set forth herein. In one or more embodiments, the software applications 38 comprise programs stored on computer-readable media of memory elements 34. Still further, the computers 12 may respectively include a display 50.

Generally, the servers 14 act as a bridge between the computers 12 and/or internal network 20 of the organization on the one hand, and the communication network 18 and APIs 16 of the outside world on the other hand. In one or more embodiments, the servers 14 also provide communication between the computers 12 and internal APIs 16. The servers 14 may include a plurality of proxy servers, web servers, communications servers, routers, load balancers, and/or firewall servers, as are commonly known.

The servers 14 also generally implement a platform for managing receipt and storage of claims data (e.g., from APIs 16) and/or performance of requested machine learning or related tasks outlined herein. The servers 14 may retain electronic data and may respond to requests to retrieve data as well as to store data. The servers 14 may comprise domain controllers, application servers, database servers, file servers, mail servers, catalog servers or the like, or combinations thereof. In one or more embodiments, one or more APIs 16 may be maintained by one or more of the servers 14. Generally, each server 14 may include a processing element 52, a memory element 54, a transceiver element 56, and a software program 58.

Each API 16 may include and/or provide access to one or more pages or sets of data and/or other content accessed through the World Wide Web (e.g., through the communication network 18) and/or through the internal network 20. Each API 16 may be hosted by or stored on a web server and/or database server, for example. The APIs 16 may include top-level domains such as “.com”, “.org”, “.gov”, and so forth. The APIs 16 may be accessed using software such as a web browser, through execution of one or more script(s) for obtaining provider data, and/or by other means for interacting with APIs 16 without departing from the spirit of the present invention.

The communication network 18 generally allows communication between the servers 14 of the organization and external APIs such as provider APIs 16. The communication network 18 may also generally allow communication between the computers 12 and the servers 14, for example in conjunction with the common authentication framework discussed above and/or secure transmission protocol(s). The internal network 20 may generally allow communication between the computers 12 and the servers 14. The internal network 20 may also generally allow communication between the servers 14 and internal APIs 16.

The networks 18, 20 may include the Internet, cellular communication networks, local area networks, metro area networks, wide area networks, cloud networks, plain old telephone service (POTS) networks, and the like, or combinations thereof. The networks 18, 20 may be wired, wireless, or combinations thereof and may include components such as modems, gateways, switches, routers, hubs, access points, repeaters, towers, and the like. The computers 12, servers 14 and/or APIs 16 may, for example, connect to the networks 18, 20 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The transceiver elements 36, 56 generally allow communication between the computers 12, the servers 14, the networks 18, 20, and/or the APIs 16. The transceiver elements 36, 56 may include signal or data transmitting and receiving circuits, such as antennas, amplifiers, filters, mixers, oscillators, digital signal processors (DSPs), and the like. The transceiver elements 36, 56 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the transceiver elements 36, 56 may utilize communication standards such as ANT, ANT+, Bluetooth™ low energy (BLE), the industrial, scientific, and medical (ISM) band at 2.4 gigahertz (GHz), or the like. Alternatively, or in addition, the transceiver elements 36, 56 may establish communication through connectors or couplers that receive metal conductor wires or cables, like Cat 6 or coax cable, which are compatible with networking technologies such as ethernet. In certain embodiments, the transceiver elements 36, 56 may also couple with optical fiber cables. The transceiver elements 36, 56 may respectively be in communication with the processing elements 32, 52 and/or the memory elements 34, 54.

The memory elements 34, 54 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 34, 54 may be embedded in, or packaged in the same package as, the processing elements 32, 52. The memory elements 34, 54 may include, or may constitute, a “computer-readable medium.” The memory elements 34, 54 may store the instructions, code, code segments, software, firmware, programs, applications, apps, services, daemons, or the like that are executed by the processing elements 32, 52. In one or more embodiments, the memory elements 34, 54 respectively store the software applications/program 38, 58. The memory elements 34, 54 may also store settings, data, documents, sound files, photographs, movies, images, databases, and the like.

The processing elements 32, 52 may include electronic hardware components such as processors. The processing elements 32, 52 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 32, 52 may include digital processing unit(s). The processing elements 32, 52 may generally execute, process, or run instructions, code, code segments, software, firmware, programs, applications, apps, processes, services, daemons, or the like. For instance, the processing elements 32, 52 may respectively execute the software applications/program 38, 58. The processing elements 32, 52 may also include hardware components such as finite-state machines, sequential and combinational logic, and other electronic circuits that can perform the functions necessary for the operation of the current invention. The processing elements 32, 52 may be in communication with the other electronic components through serial or parallel links that include universal busses, address busses, data busses, control lines, and the like.

Returning to FIG. 1, the servers 14 may manage queries to, and responsive provider data received from, APIs 16, and perform related analytical functions (e.g., as requested by one or more of the computing devices 12) in accordance with the description set forth herein. In one or more embodiments, the provider data may be acquired by other means, and the steps for analysis laid out herein may be requested and/or performed by different computing devices (or by a single computing device), without departing from the spirit of the present invention.

The provider data may be stored in databases managed by the servers 14 utilizing any of a variety of formats and structures within the scope of the invention. For instance, relational databases and/or object-oriented databases may embody such databases. Similarly, the APIs 16 and/or databases may utilize a variety of formats and structures within the scope of the invention, such as Simple Object Access Protocol (SOAP), Remote Procedure Call (RPC), and/or Representational State Transfer (REST) types. One of ordinary skill will appreciate that—while examples presented herein may discuss specific types of databases—a wide variety may be used alone or in combination within the scope of the present invention.

Through hardware, software, firmware, or various combinations thereof, the processing elements 32, 52 may—alone or in combination with other processing elements—be configured to perform the operations of embodiments of the present invention. Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled.

### Exemplary Computer-Implemented Method for Detecting Procedure and Diagnosis Code Anomalies Through Matrix-to-Graphical Cluster Transformation of Provider Service Data

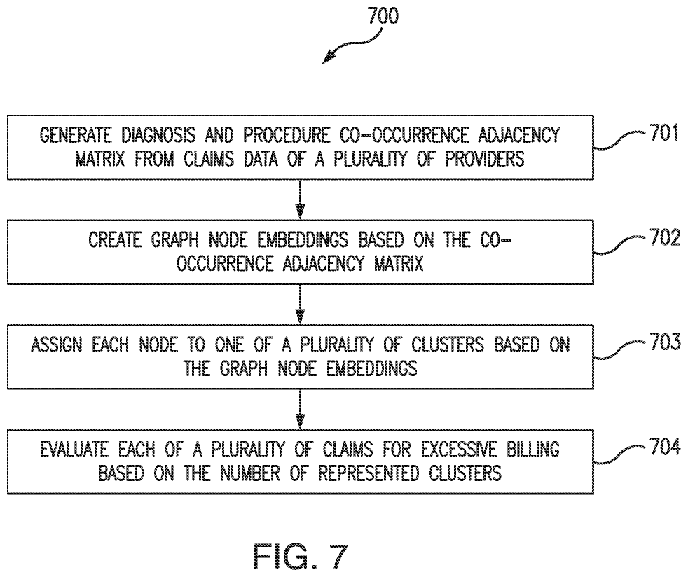

FIG. 7 depicts a flowchart including a listing of steps of an exemplary computer-implemented method 700 for detecting procedure and diagnosis code anomalies in provider service data. The steps may be performed in the order shown in FIG. 7, or they may be performed in a different order. Furthermore, some steps may be performed concurrently as opposed to sequentially. In addition, some steps may be optional.

The computer-implemented method 700 is described below, for ease of reference, as being executed by exemplary devices and components introduced with the embodiments illustrated in FIGS. 1-3. For example, the steps of the computer-implemented method 100 may be performed by the computer 12, the server 14 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention and, in many embodiments, will be performed by a single computing device or server. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 701, a diagnosis and procedure co-occurrence adjacency matrix may be generated from claims data of a plurality of providers. Step 701 may be executed by one or both of a computing device and a server. The claims data may be obtained periodically, continuously and/or upon request from a variety of sources. For example, an automated data acquisition process may cause intermittent batch downloads of claims data from APIs associated with healthcare service providers and/or third-party databases storing such data to network servers and/or computing devices.

The claims data or provider data populating the adjacency matrix may be extracted from tabulated claims data regarding, for example, inpatient and/or outpatient medical insurance claims submitted by the plurality of providers. In one or more embodiments, the plurality of providers will be selected according to, for example, specialty, size, geographic location, or other criteria. The selection criteria may be determined at least in part based on observing the impact of various combinations of criteria on accuracy of overbilling predictions using the model(s) described herein. In one or more embodiments, for example, only general practitioner data from the same geographic region and submitted by practitioners within a pre-determined practice size range are used to construct the adjacency matrix.

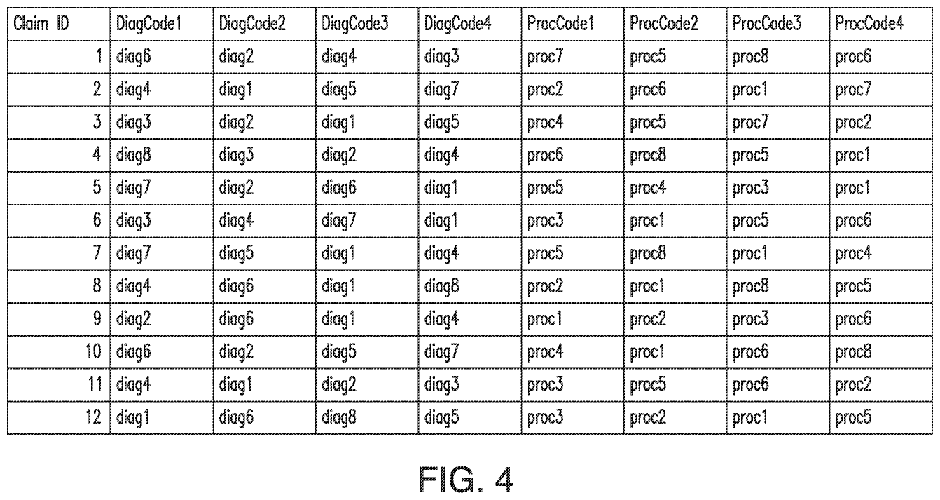

FIG. 4 illustrates exemplary tabulated claims data in a chart format. Each of the illustrated claims 1-12 includes four (4) diagnosis codes (e.g., according to the classification system propagated under the identifier INTERNATIONAL CLASSIFICATION OF DISEASES (ICD) as of the date of initial filing of the present disclosure). Each of the illustrated claims 1-12 also includes four (4) procedure codes (e.g., according to the classification system propagated under the identifier CURRENT PROCEDURAL TERMINOLOGY (CPT) as of the date of initial filing of the present disclosure). One of ordinary skill will appreciate that different tabular formats, and more or fewer diagnosis and/or procedure codes may appear in one or more of the claims of the provider data without departing from the spirit of the present invention. It should also be appreciated that the illustrated data is merely a random distribution intended to demonstrate the relationship between the provider data and the adjacency matrix, and does not reflect the likelihood that any given diagnoses or procedures would co-occur in real data.

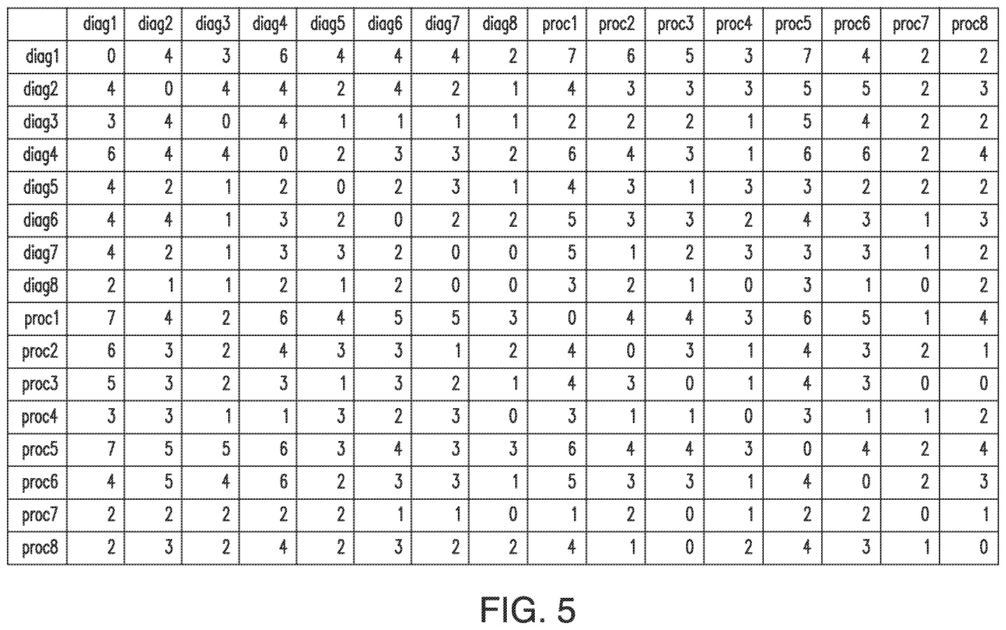

Turning to FIG. 5, an exemplary adjacency matrix is constructed with all possible diagnosis and procedure codes listed in identical order as column and row headers (left to right column headers and top to bottom row headers). Each instance in which a first diagnosis and a second diagnosis, or the first diagnosis and a first procedure, or the first procedure and a second procedure appear together in the same claim, a count specific to that pairing is incremented once. The same is true for each possible combination of diagnosis and/or procedure codes. Thus, FIG. 5 lists at the vertex of each such pairing the number or count of corresponding co-occurrences in the aggregated claims data of the plurality of providers. As one of ordinary skill will appreciate with respect to adjacency matrices generally, this construction generates a diagonal of zeros beginning at the top left of the matrix, with mirrored values extending outward from the diagonal.

It is foreseen that the relationships captured in the exemplary co-occurrence adjacency matrix may be captured via tables and/or matrices of varied construction without departing from the spirit of the present invention.

Referring to step 702, graph node embeddings may be created based on the co-occurrence adjacency matrix. Step 702 may be executed by one or both of a computing device and a server. The co-occurrence network represented by the adjacency matrix generated in connection with step 701 may be represented with low dimensionality by implementation of an encoder function that seeks to retain important aspects of the relationships observed in the original network. For example, the graph node embeddings may reflect the count of co-occurrences in the adjacency matrix as edge weights between the corresponding nodes, and the encoder may be configured or discovered which uses dot products between node embeddings to approximate edge existence and minimize loss resulting from the encoding. In one or more embodiments, the embedding matrix may be determined using stochastic gradient descent (SGD). In one or more embodiments, matrix decomposition solvers may be utilized to determine the embedding matrix. Readily available techniques that may be used with embodiments of the present invention also include algorithms made available under one or more of the following identifiers as of the initial filing date of the present disclosure: node2vec, DeepWalk, and LINE. However, one of ordinary skill will appreciate that a variety of graph node embedding techniques or algorithms may be utilized without departing from the spirit of the present invention.

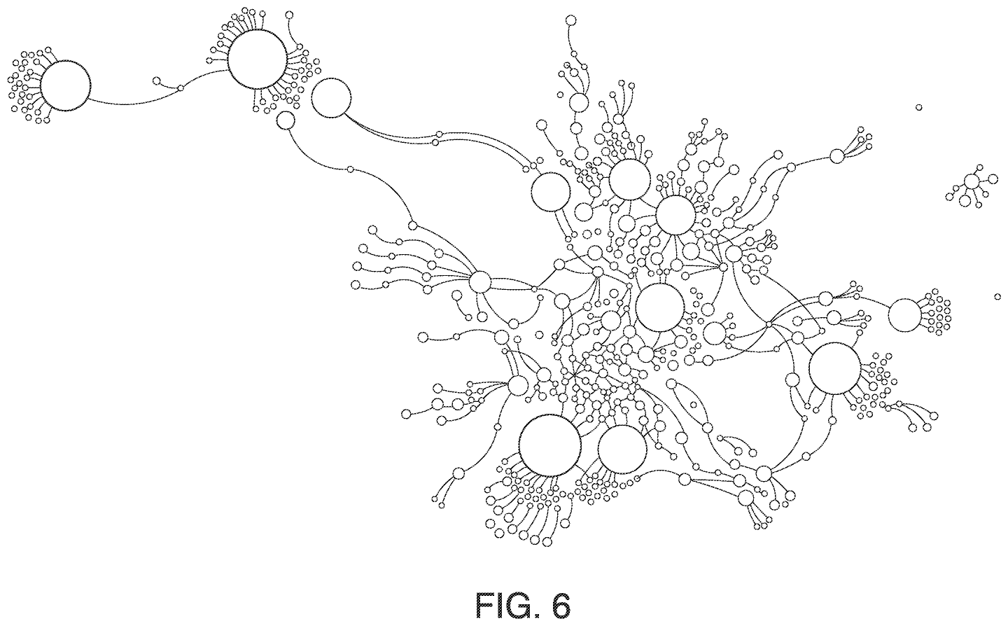

Referring to step 703, each node of the graph node embeddings may be assigned to one of a plurality of clusters. Step 703 may be executed by one or both of a computing device and a server. Each node—corresponding to one of the diagnosis or procedure codes—may be assigned to one of the plurality of clusters using any graph clustering algorithm, such as spectral clustering and/or attributed graph clustering algorithms. The number of clusters may be taken as a hyperparameter in such algorithms(s), and one of ordinary skill will appreciate that the number of clusters can be adjusted iteratively to both increase sensitivity to overbilling or instances of fraud and reduce false positives. FIG. 6 illustrates exemplary clusters generated from graph node embeddings for use in connection with embodiments of the present invention. In an example, each of the nodes may be assigned to one of four (4) clusters. In other embodiments, the number of diagnosis and procedure codes accounted for will be significantly larger, and the number of clusters identified may also increase.

Referring to step 704, a new claim may be evaluated for excessive billing based on the number of clusters represented in the claim. Step 704 may be executed by one or both of a computing device and a server. In one or more embodiments, claims may be evaluated individually and/or in the aggregate with respect to a specific provider. For example, on an individual level, a first claim submitted by a first healthcare provider may include claim and diagnosis codes respectively from clusters Two, Three and Four. That is, the first claim may include elements of three (3) of the four (4) identified clusters.

The type and/or number of represented clusters in the claim may be evaluated against one or both of a pre-determined threshold and a pre-determined rule. The pre-determined threshold may, for example, be two (2) clusters. The pre-determined rule may be that a pre-determined combination of clusters is impermissible (e.g., clusters Two and Four should never appear together in the same claim). One or both of the threshold and rule may be applied to the claim in question to determine whether a flag or warning should be thrown regarding the likelihood that overbilling is present. In the example of the first claim, both the threshold and the pre-determined rule will throw flags simultaneously based on the representation of clusters Two, Three and Four in the first claim.

In addition, a plurality of claims from the same provider may be evaluated individually (e.g., substantially in the manner outlined above), and the aggregate findings for the plurality of claims may be evaluated against a separate threshold or rule applicable more generally to the provider. For example, if more than ten (10) claims from the provider within a seven (7) day timeframe receive flags or warnings based on individual claim analysis, the provider itself may be flagged as a potential overbiller or fraudulent provider. For another example, if a threshold proportion or percentage (e.g. at least seventy percent (70%)) of claims submitted by the provider have a pre-determined type or profile and also result in a suspicious flag on the level of individual analysis, the pattern may reflect a preferred mode of overbilling for the provider and the provider may consequently be flagged as a potential overbiller or fraudulent provider. It is foreseen that a wide variety of thresholds and/or rules may be applied to predict overbilling risks using such clustering approaches without departing from the spirit of the present invention.

It should be noted that, while this disclosure discusses application of embodiments of the present invention from the perspective of determining possible overbilling among healthcare providers, it is foreseen that the specific, concrete set of steps for data transformation to a lower-dimensional embedded space that allows revelation of previously undetectable relationships and correlations of the present disclosure may be utilized with service or good providers of a variety of types without departing from the spirit of the present invention.

The method may include additional, less, or alternate steps and/or device(s), including those discussed elsewhere herein.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as transceiver elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. A computer-implemented method for detecting procedure and diagnosis code anomalies in provider service data comprising, via one or more transceivers and/or processors:
generating a co-occurrence adjacency matrix from service provider data of a plurality of providers, the adjacency matrix including counts of the number of co-occurrences of a plurality of diagnoses and a plurality of procedures in the service provider data;
creating a plurality of graph node embeddings based on the adjacency matrix;
assigning each of the plurality of graph node embeddings to one of a plurality of clusters; and
evaluating a health insurance claim for excessive billing based on how many of the plurality of clusters is represented in the claim.

2. The computer-implemented method of claim 1, wherein each of the plurality of graph node embeddings corresponds to one of the plurality of diagnoses or one of the plurality of procedures.

3. The computer-implemented method of claim 1, wherein the plurality of graph node embeddings are created using algorithms made available under one or more of the following identifiers as of the initial filing date of the present disclosure: NODE2VEC, DEEPWALK, and LINE.

4. The computer-implemented method of claim 1, wherein the service provider data comprises elements of claims submitted by the plurality of providers, the elements for each of the claims including a diagnosis code and a procedure code.

5. The computer-implemented method of claim 4, wherein the plurality of graph node embeddings is created based in part on the counts of the adjacency matrix.

6. The computer-implemented method of claim 4, wherein each diagnosis code conforms to the classification system propagated under the identifier INTERNATIONAL CLASSIFICATION OF DISEASES (ICD), and each procedure code conforms to the classification system propagated under the identifier CURRENT PROCEDURAL TERMINOLOGY (CPT).

7. The computer-implemented method of claim 1, wherein the assignment to the plurality of clusters is performed using a graph clustering algorithm chosen from among spectral clustering and attributed graph clustering algorithms.

8. A system for detecting procedure and diagnosis code anomalies in provider service data, the system comprising one or more processors individually or collectively programmed to:
generate a co-occurrence adjacency matrix from service provider data of a plurality of providers, the adjacency matrix including counts of the number of co-occurrences of a plurality of diagnoses and a plurality of procedures in the service provider data;
create a plurality of graph node embeddings based on the adjacency matrix;
assign each of the plurality of graph node embeddings to one of a plurality of clusters; and
evaluate a health insurance claim for excessive billing based on how many of the plurality of clusters is represented in the claim.

9. The system of claim 8, wherein each of the plurality of graph node embeddings corresponds to one of the plurality of diagnoses or one of the plurality of procedures.

10. The system of claim 8, wherein the plurality of graph node embeddings are created using algorithms made available under one or more of the following identifiers as of the initial filing date of the present disclosure: NODE2VEC, DEEPWALK, and LINE.

11. The system of claim 8, wherein the service provider data comprises elements of claims submitted by the plurality of providers, the elements for each of the claims including a diagnosis code and a procedure code.

12. The system of claim 11, wherein the plurality of graph node embeddings is created based in part on the counts of the adjacency matrix.

13. The system of claim 11, wherein each diagnosis code conforms to the classification system propagated under the identifier INTERNATIONAL CLASSIFICATION OF DISEASES (ICD), and each procedure code conforms to the classification system propagated under the identifier CURRENT PROCEDURAL TERMINOLOGY (CPT).

14. The system of claim 8, wherein the assignment to the plurality of clusters is performed using a graph clustering algorithm chosen from among spectral clustering and attributed graph clustering algorithms.

15. A non-transitory computer-readable storage media having computer-executable instructions for detecting procedure and diagnosis code anomalies in provider service data stored thereon, wherein when executed by at least one processor the computer-executable instructions cause the at least one processor to:
generate a co-occurrence adjacency matrix from service provider data of a plurality of providers, the adjacency matrix including counts of the number of co-occurrences of a plurality of diagnoses and a plurality of procedures in the service provider data;
create a plurality of graph node embeddings based on the adjacency matrix;
assign each of the plurality of graph node embeddings to one of a plurality of clusters; and
evaluate a health insurance claim for excessive billing based on how many of the plurality of clusters is represented in the claim.

16. The non-transitory computer-readable media of claim 15, wherein each of the plurality of graph node embeddings corresponds to one of the plurality of diagnoses or one of the plurality of procedures.

17. The non-transitory computer-readable media of claim 15, wherein the plurality of graph node embeddings are created using algorithms made available under one or more of the following identifiers as of the initial filing date of the present disclosure: NODE2VEC, DEEPWALK, and LINE.

18. The non-transitory computer-readable media of claim 15, wherein the service provider data comprises elements of claims submitted by the plurality of providers, the elements for each of the claims including a diagnosis code and a procedure code.

19. The non-transitory computer-readable media of claim 18, wherein the plurality of graph node embeddings is created based in part on the counts of the adjacency matrix.

20. The non-transitory computer-readable media of claim 15, wherein the assignment to the plurality of clusters is performed using a graph clustering algorithm chosen from among spectral clustering and attributed graph clustering algorithms.
